(19) United States
(12) Patent Application Publication
(10) Pub. No.: US 2026/0192935 A1
(43) Pub. Date: Jul. 9, 2026

(54) IMPROVED PROPULSION ASSEMBLY FOR A MULTI-ENGINE AIRCRAFT

(71) Applicant: SAFRAN HELICOPTER ENGINES, Bordes (FR)

(72) Inventors: Quentin VINCENZOTTO, Moissy-Cramayel (FR); Olivier BEDRINE, Moissy-Cramayel (FR)

(73) Assignee: SAFRAN HELICOPTER ENGINES, Bordes (FR)

(21) Appl. No.: 18/870,064

(22) PCT Filed: May 29, 2023
(86) PCT No.: PCT/FR2023/050748

§ 371 Date: Jul. 18, 2025

(30) Foreign Application Priority Data
May 31, 2022 (FR) 2205194

(51) Int. Cl. B64D 15/04; B64C 27/12; B64D 27/10; B64D 33/00; F02C 9/18

(52) U.S. Cl. CPC B64D 33/00; B64C 27/12; F02C 9/18

(57) ABSTRACT

Propulsion assembly (100) for an aircraft, particularly for a multi-engine helicopter, comprising at least one first engine (1) and a second engine (2) configured to operate in at least one standby mode, a primary air circulation device (30) configured to bleed air from the first engine (1) via a first bleed channel (310) and/or from the second engine (2) via a second bleed channel (320) to convey it to equipment of the propulsion assembly (100), and a secondary air circulation device (40) configured, when one of the first or the second engine (1, 2) operates in standby mode, to bleed air originating from the other of the first or the second engine (1, 2) not operating in standby mode and to convey it to the first or the second engine (1, 2) operating in standby mode.

### TECHNICAL FIELD

The present invention relates to the field of aircraft comprising at least two engines such as turboshaft engines or turboprop engines, for flying machines such as helicopters or twin-engine airplanes. In particular, the invention relates to thermal management of the components of a propulsion assembly for a multi-engine, particularly twin-engine, aircraft, and a thermal management method for such a propulsion assembly.

### PRIOR ART

Most helicopters include two or more turbine engines, for example turboshaft engines or turboprop engines, each comprising a gas turbine. This is the case in particular with twin-engine or multi-engine helicopters. Such aircraft allow operation in economy mode, called “ECO” mode. ECO mode is an operating mode, generally corresponding to a cruise flight phase, of a twin-engine architecture in which one of the gas turbines is in standby mode, i.e. is stopped (combustion chamber stopped, or “OFF,” with the gas generator being able to be driven at a certain speed via an electrical machine) or operates at super-low idle at very low speed (combustion chamber lit or “ON”), for example at a rotation speed less than 40% of the nominal rotation speed, the other gas turbine providing the entire power supply.

This mode allows optimizing the specific fuel consumption, which decreases with the power supplied by a turbine engine. In fact, the specific fuel consumption of a turbine decreasing with the power supplied, it is preferable to supply 100% of the power with one, rather than 50% from each of them. Document FR2967133A1 describes an example of application of the ECO mode on a twin-engine helicopter.

However, depending on operational climatic conditions, the ECO mode can lead to conditions favorable to ice formation in the stream of air of the engine operating in standby mode, i.e. stopped or rotating at super-low idle. This engine not being able to feed itself to provide anti-icing, the temperature of its own parts or components can no longer prevent the appearance of ice. Moreover, during operation in ECO mode, when one of the two engines is stopped (combustion chamber “OFF”), the temperature of the combustion chamber of this engine will not allow its normal or rapid restarting in case of necessity.

Devices for circulating hot air in twin-engine helicopters exist, allowing the bleeding of hot air from one or from both engines, originating from different places in the hot air flow stream of these engines. For this purpose, these devices comprise, for each engine, a bleed channel having a solenoid valve (or “SOV” for “ShutOff Valve) allowing the air bleed from the engine in question to be activated or deactivated, and a check valve providing for non-recirculation of the air to the engine, thus preventing transfers of air between the two engines.

This hot air bleed can be used in particular for pressurization or air conditioning. However, existing hot air circulation devices do not allow managing the problems mentioned above, such as the accumulation of ice, linked to the heating of the components of the engine operating in standby mode. There exists therefore a need for a solution responding at least in part to the previously mentioned disadvantages.

### Disclosure of the Invention

The present disclosure relates to a propulsion assembly for an aircraft, particularly a multi-engine helicopter, comprising:
at least one first engine and a second engine configured to operate in at least one standby mode,
a primary air circulation device configured to bleed air from the first engine via a first bleed channel and/or from the second engine via a second bleed channel to convey it to equipment of the propulsion assembly, and
a secondary air circulation device configured, when one of the first or second engine operates in the at least one standby mode, to bleed air originating from the other of the first engine or the second engine not operating in standby mode and to convey it to the first or the second engine operating in standby mode.

What is understood by “standby mode” is a mode in which the combustion chamber of the gas turbine of one of the engines is shut down, or the engine operates at super-low idle. When it operates at super-low idle, the combustion chamber is fired and the rotating parts of the gas turbine rotate for example at a speed less than 40% of a nominal rotation speed. Thus it is understood that when the first engine is in standby mode, the second engine is not in standby mode and supplies the entire power of the aircraft, and conversely.

In the present disclosure, the terms “upstream” and “downstream” are considered according to the normal direction of air flow in the different channels defined hereafter. For example, in the first and the second channel defined hereafter, the “upstream-downstream” direction corresponds to the direction running from the bleed point on the first or the second engine to the equipment of the propulsion assembly. Likewise, in the third channel defined hereafter, the “upstream-downstream” direction corresponds to the direction running toward the injection point of the first or second engine.

The primary air circulation device is configured to bleed air in the first and/or the second engine, i.e. bleed hot air flowing in the air stream of these engines, for example at the combustion chamber. To this end, the first engine is equipped with a first bleed channel, and the second engine is equipped with a second bleed channel.

The first and the second channel can then converge while joining at a downstream channel, the latter being able to convey air bled in the first engine and/or from the second engine to equipment of the propulsion assembly. Thus it is understood that the quantity of air conveyed to said equipment via the downstream channel is the sum of the quantities of air bled from each of the first and second engine.

The equipment of the propulsion assembly to which air from the primary air circulation device is conveyed can be a pressurization device, an air conditioner, a component of the propulsion assembly to be cooled, the wings or the flaps of the aircraft.

In addition to the primary air circulation device, the propulsion assembly comprises a secondary air circulation device. Unlike the primary device, this secondary device allows transfer of hot air flowing in the flow stream of one of the two engines to the air flow stream of the other of the two engines. In other words, the secondary air circulation device allows bleeding air in the active engine (for example the first engine), i.e. the engine not operating in standby mode and supplying the entire power, and conveying the bled air to the engine operating in standby mode (the second engine for example).

Thus, when it is detected, during cruise flight, that conditions likely to cause the formation of ice on certain components of the engine operating in standby mode exist, it is possible, by means of the secondary air circulation device, to use the available hot air in the active engine, and thus limiting the formation of ice in the engine in standby mode. Moreover, the injection of hot air into the combustion chamber of the engine operating in standby mode can also allow holding said combustion chamber at a higher temperature, allowing easier and more rapid starting of the engine in case of necessity, for example in the event of breakdown of the active engine.

In certain embodiments, the first and the second bleed channel are configured to bleed air from the first and the second engine at a first bleed point of the first and of the second engine respectively, the secondary air circulation device comprising a third bleed channel configured to bleed air from one of the first or the second engine at a second bleed point of said first or second engine, and to convey the air to an injection point of the other of the first or the second engine, the injection point being distinct from the first bleed point.

It will be noted that, in the configurations of twin-engine aircraft equipped with a hot air circulation device, the engines can be equipped with a double air bleed boss. Thus, the first bleed point of each of the first and the second engine can be one of these two air bleed bosses. Likewise, the second bleed point, distinct from the first bleed point, and the injection point of the third bleed point, can be on the other of these two air bleed bosses, respectively.

In other words, according to this embodiment, the secondary air circulation device is distinct from the primary air circulation device, the second bleed point of the third bleed channel in one of the two engines and the injection point of the third bleed channel in the other of the two motors being distinct and preferably at a distance from the first bleed points of the primary air circulation device. Thus it is possible to use the hot air available from the active engine, and thus limit the formation of ice in the engine in standby mode, without modifying the existing primary air circulation device.

In certain embodiments, the air is conveyed to at least one injection point of the first or the second engine operating in standby mode, the injection point being located on a member of said engine, the member being one of a compressor, a combustion chamber, an inlet guide vane (or IGV), or an air inlet.

In certain embodiments, the first and the second engine comprise a compressor, the second bleed point being arranged at the outlet of the compressor, or between two stages of the compressor. The second bleed point can be positioned depending on the needed flow rate and/or the temperature of the air.

In certain embodiments, the injection point is arranged so as to inject air into one air inlet of the first or the second engine, between the stages of the compressor, or into the combustion chamber.

In certain embodiments, the third bleed channel comprises a solenoid valve and a check valve.

The solenoid valve, being able to be controlled by a control unit, allows activating or deactivating the air bleed in the active engine. Moreover, the check valve, arranged downstream of the solenoid valve, provides for non-recirculation of the air and prevents transfers from the engine which has left the standby mode to the active engine. It is also understood that this configuration is asymmetrical, the air transfer being able to occur only from the first engine (for example) to the second engine, and not the reverse. In other words, only the second engine is intended to operate in standby mode. This configuration allows simplifying starting the secondary air circulation device, requiring only the addition of a solenoid valve/check valve pair.

In certain embodiments, the secondary air circulation device comprises a bypass device arranged on one of the first or the second bleed channel.

According to this embodiment, the secondary air circulation device is not distinct from the primary air circulation device, but involves a modification of the latter by the addition of the bypass device. Thus, unlike the architecture defined previously, it is not necessary in this particular case that each engine comprises a double air bleed boss, because bleed and injection of air in the engine operating in standby mode can be accomplished at the same locations as the primary circulation device. Alternatively, one of the two bosses can be blocked.

This allows obtaining the technical effects mentioned earlier, linked in particular to the anti-icing of the components of the engine operating in standby mode, while simplifying the overall architecture of the propulsion assembly, and while limiting in particular the bulk involved in the air circulation devices.

In certain embodiments, the bypass device is configured to allow an air flow originating from one of the first or second engine not operating in standby mode to the other of the first or second engine operating in standby mode, while preventing an air flow in the opposite direction.

In other words, the bypass device is configured in such a manner as to allow a flow from the active engine to the engine operating in standby mode when that is necessary and, when such a flow occurs, preventing the flow of air in the reverse direction, i.e. toward the active engine, particularly when the engine operating in standby mode leaves this standby mode and passes back into a nominal operating mode. Thus, although the bypass device is arranged on the primary circulation device, it is possible, outside of the ECO mode, to bleed air from both engines through the primary circulation device, and in ECO mode, to transfer air from the active engine to the engine in standby mode through the secondary circulation device.

In certain embodiments, the first and the second bleed channel comprise a solenoid valve and a check valve, the bypass device comprising a bypass channel comprising a solenoid valve, a first end of the bypass channel being in communication with said first or second bleed channel downstream of the check valve of said first or second bleed channel.

It is understood that the first end of the bypass channel communicates with the first bypass channel (for example), downstream of the check valve, itself downstream of the solenoid valve of the first bypass channel in the flow direction of the air in the first bypass channel from the first engine. Thus, air can flow to the first engine in standby mode only via the first bleed channel considering the presence of the check valve, but can do it via the bypass channel by opening the solenoid valve of said bypass channel.

In certain embodiments, a second end of the bypass channel is in communication with said first or second bleed channel between the solenoid valve and the check valve of said first or second bleed channel.

This configuration allows circumventing the check valve of the first bleed channel (for example). Thus, air can flow from the active engine (the second engine in this example) to the engine in standby mode (the first engine in this example), via the bypass channel then the first bleed channel, by opening the solenoid valve of the bypass channel and of the first bleed channel respectively.

In certain embodiments, the first and the second bleed channels are configured to bleed air from the first and from the second engine at a bleed point of the first and the second engine respectively, the bypass channel comprising a check valve mounted in opposition to the check valve of the first or the second bleed channel, a second end of the bypass channel being in communication with said first or second bleed channel, between the solenoid valve and the bleed point of said first or second bleed channel.

What is understood by “mount in opposition” is that when the air flows in a first flow direction, from the engine in standby mode, it can flow in the first bleed channel (for example), but not in the bypass channel considering the presence of the check valve. On the contrary, when the air flows in a second flow direction opposite to the first direction, to the engine in standby mode, it can flow in the bypass channel, but not in the first bleed channel considering the presence of the check valve.

In addition, the first end communicating with the first bleed channel (for example) between the solenoid valve of the first bleed channel and the bleed point, it is thus possible, in ECO mode, to inject air originating from the active engine into the engine in standby mode, at the same point (the bleed point) through which the air is bled outside of ECO mode. This allows limiting the modifications of engines and consequently simplifying the architecture of the propulsion assembly.

In certain embodiments, the first and the second bleed channels are configured to bleed air from the first and the second engine at a bleed point of the first and second engine respectively, the bypass channel comprising a check valve mounted in opposition to the check valve of the first or second bleed channel, a second end of the bypass channel being configured to inject air into the first or the second engine operating in standby mode, at an injection point distinct from the bleed point.

The fact of arranging the second end of the bleed channel, not on the first bypass channel (for example), but rather at an injection point of the engine in standby mode distinct from the bleed point, allows freely choosing said injection point depending on the zone or the components of the engine to be heated.

In certain embodiments, the bypass channel comprises a limiter arranged between the check valve and the injection point, the limiter being configured to regulate a flow rate of air flowing in the bypass channel.

The limiter can be arranged downstream of the check valve of the bypass channel, and can be an adjustable constriction of the bypass channel, allowing regulating the air flow injected into the engine in standby mode depending on the temperatures of the zones or the components of the engine to be heated. The limiter can also be controlled by a control unit.

In certain embodiments, the first and the second bleed channels comprise a three-way valve and a check valve, the bypass device comprising a bypass channel, a first end of the bypass channel being in communication with said first or second bleed channel downstream of the check valve of said first or second bleed channel, a second end of the bypass channel being connected to the three-way valve, the three-way valve being movable between a first position allowing an air flow in said first or second bleed channel and preventing a flow of air in the bypass channel, and a second position preventing an air flow in said first or second bleed channel and allowing an air flow in the bypass channel.

The three-way valve can be controlled by a control unit, to pass from the first to the second position, in ECO mode. This configuration allows simplifying the structure of the bypass channel, not necessitating a solenoid valve, a single valve (the three-way valve) being necessary.

In certain embodiments, the first and second bleed channel comprise a solenoid valve, the bypass device comprising a movable check valve arranged on the first or the second bleed channel, the movable check valve being movable between a first position allowing an air flow in said first or second bleed channel in a first circulation direction and preventing an air flow in a second circulation direction opposite to the first direction, and a second position allowing an air flow in the second circulation direction and preventing an air flow in the first circulation direction.

The movable check valve can be controlled by a control unit, so as to pivot on itself to pass from the first to the second position, in ECO mode and outside ECO mode. More precisely, outside ECO mode, air can be bled from the first engine (for example) while flowing in the first bleed channel, the movable check valve being in the first position, preventing the return of the air to the engine. On the contrary, in ECO mode, the movable check valve is arranged in the second position, so as to allow an air flow originating from the second active engine to the first engine in standby mode, the second position preventing moreover the return of the air to the second engine.

This configuration allows dispensing with the use of a bypass channel, thus further simplifying the architecture of the propulsion assembly. In this regard, it is understood that the flow from the active engine to the engine in standby mode in ECO mode is allowed by the pressure difference existing between these engines, and by the movable check valve arranged in its second position, the solenoid valve being open moreover.

In certain embodiments, the first and second bleed channels comprise a solenoid valve, the bypass device comprising a blockable check valve arranged on the first or the second bleed channel, the blockable check valve being configured to be blocked in an open position allowing an air flow in both circulation directions.

The blockable check valve can be controlled by a control unit, so as to be able to be blocked in the open position and thus allow air flow in both circulation directions. More precisely, outside of ECO mode, air can be bled from the first engine (for example) while flowing in the first bleed channel, the blockable check valve preventing return of the air to the engine. On the contrary, in ECO mode, the blockable check valve is blocked in the open position, so as to allow a flow of the air originating from the second active engine to the first engine in standby mode.

In this particular case, the flow from the active engine to the engine in standby mode in ECO mode is allowed by the difference in pressure existing between these engines, and by the check valve blocked in the open position. This configuration allows dispensing with the use of a bleed channel, thus further simplifying the architecture of the propulsion assembly.

The present disclosure also relates to an aircraft comprising a propulsion assembly according to any one of the preceding embodiments, the aircraft being a multi-engine, particularly twin-engine, helicopter.

The present disclosure also relates to a method for thermal management of a propulsion assembly according to any one of the preceding embodiments, comprising:
detecting operation in at least one standby mode by one of the first engine or the second engine,
measuring the temperature of at least one component of said first engine or second engine operating in the standby mode, and
if the measured temperature is less than or equal to a predetermined threshold value, bleeding air from the other of the first engine or the second engine not operating in standby mode, and conveying air to the first or the second engine operating in standby mode, by means of the secondary air circulation device.

ECO mode implies that one of the first engine or the second engine is in standby mode. Icing conditions can then occur in this engine. To detect such conditions, temperature sensors such as thermocouples can be arranged within the engine in standby mode, particularly on one or more component(s) of this engine, or within the combustion chamber. These sensors can be connected to a control unit which determines whether one at least of the sensors notes a temperature less than or equal to a predetermined threshold value, indicating for example the possibility of the appearance of ice. In this case, the control unit commands the opening of the solenoid valve of the secondary air circulation device, or of the three-way valve, or of the movable check valve, or even of the blockable check valve, to allow the flow of air from the active engine to the engine in standby mode.

### BRIEF DESCRIPTION OF THE DRAWINGS

The invention and its advantages will be better understood upon reading the detailed description given hereafter of different embodiments of the invention given by way of non-limiting examples. This description refers to the appended pages of figures, in which:

FIG. 1 shows a section view of a propulsion assembly for a twin-engine aircraft according to a first embodiment of the invention,

FIG. 2 shows a section view of a propulsion assembly for a twin-engine aircraft according to a second embodiment of the invention,

FIG. 3 shows an isolated part of the first bleed channel of the propulsion assembly of FIG. 2, according to a first modified example of the second embodiment,

FIG. 4 shows an isolated part of the first bleed channel of the propulsion assembly of FIG. 2, according to a second modified example of the second embodiment,

FIG. 5 shows an isolated part of the first bleed channel of the propulsion assembly of FIG. 2, according to a third modified example of the second embodiment,

FIG. 6 shows an isolated part of the first bleed channel of the propulsion assembly of FIG. 2, according to a fourth modified example of the second embodiment,

FIG. 7 shows an isolated part of the first bleed channel of the propulsion assembly of FIG. 2, according to a fifth modified example of the second embodiment,

FIG. 8 shows an isolated part of the first bleed channel of the propulsion assembly of FIG. 2, according to a sixth modified example of the second embodiment,

FIG. 9 shows schematically the different steps of a thermal management method for a propulsion assembly according to the invention.

### DESCRIPTION OF THE EMBODIMENTS

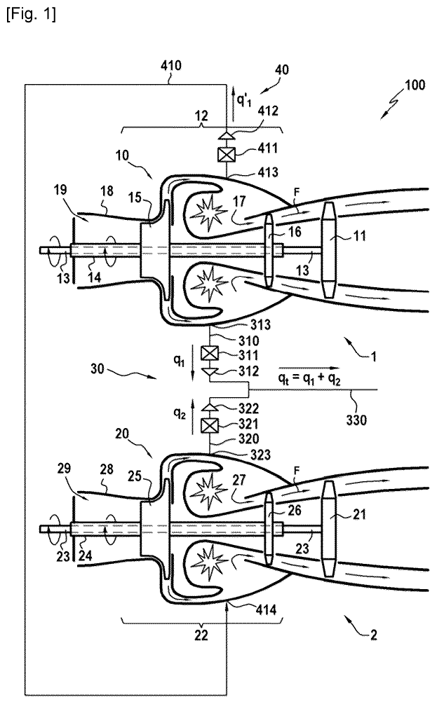

An architecture of a propulsion assembly 100 according to a first embodiment of the invention will be described in the continuation of the description, with reference to FIG. 1.

FIG. 1 shows schematically a propulsion assembly 100 of a twin-engine aircraft, comprising a first turbine engine 1 and a second turbine engine 2, driving in rotation the transmission members of a helicopter bearing a main propeller or rotor (not shown). The turbine engines 1, 2 can be turboshaft or turboprop engines, and will be more simply named respectively first engine 1 and second engine 2 in the continuation of the description. Although the propulsion assembly described in the continuation of the description comprises two engines, this example is not limiting, the invention also being applicable to propulsion assemblies of multi-engine aircraft comprising more than two engines.

The first engine 1 and the second engine 2 are preferably identical and have the same features. Thus the description below refers both to the first and to the second engine 1, 2.

The first engine 1 and the second engine 2 comprise respectively a gas turbine 10, 20 having a gas generator 12, 22 and a free turbine 11, 21 able to be driven in rotation by a gas flow generated by the gas generator 12, 22. The free turbine 11, 21 is mounted on a shaft 13, 23 that transmits the rotation movement to a receiving member such as the main rotor of the helicopter (not shown).

The gas generator 12, 22 includes a rotating shaft 14, 24 on which are mounted a compressor 15, 25 and a turbine 16, 26, as well as a combustion chamber 17, 27 arranged axially between the compressor 15, 25 and the turbine 16, 26 provided that the gas generator 12, 22 is considered to be in the axial direction of the rotating shaft 14, 24. The gas turbine 10, 20 has a casing 18, 28 provided with an air inlet 19, 29 through which fresh air enters into the gas generator 12, 22. After its induction into the casing of the gas generator 12, 22, the fresh air is compressed by the compressor 15, 25 which discharges it into the intake of the combustion chamber 17, 27 in which it is mixed with fuel. The combustion that occurs in the combustion chamber 17, 27 causes the outflow of the burned gases at high speed to the turbine 16, 26, which has the effect of driving the shaft 14, 24 of the gas generator 12, 22 in rotation, and consequently the compressor 15, 25. The speed of rotation of the shaft 14, 24 of the gas generator 12 22 is determined by the flow rate of fuel entering the combustion chamber 17, 27.

Despite the extraction of kinetic energy by the turbine 16, 26, the gas flow leaving the gas generator has significant kinetic energy. As can be understood by means of FIG. 1, the gas flow F is directed to the free turbine 11, 21 which has the effect of causing expansion in the free turbine 11, 21 leading to the driving in rotation of the turbine wheel and of the shaft 13, 23.

The propulsion assembly 100 also includes a primary air circulation device 30, allowing bleeding hot air flowing in the air stream of the first engine 1 and/or the second engine 2, to convey it to equipment (not shown) of the propulsion assembly 100, which can be a pressurization device, an air conditioner, a component of the propulsion assembly to be cooled, the wings or the flaps of the aircraft.

To this end, the primary air circulation device 30 comprises a first bleed channel 310 for bleeding air from the first engine 1, and a second bleed channel 320 for bleeding air from the second engine 2. The first and the second bleed channel 310, 320 then join at a branching from which extends a downstream channel 330, leading to said equipment of the propulsion assembly 100.

It will be noted moreover that the terms “upstream” and “downstream” are considered along the normal flow direction of the air in the different channels, this flow direction being moreover symbolized by arrows in FIG. 1 and the following figures.

The bleeding of hot air from the first engine 1 through the first bleed channel 310 occurs at a first bleed point 313, arranged for example facing the combustion chamber 17. Likewise, the bleeding of hot air from the second engine 2 through the second bleed channel 320 occurs at a first bleed point 323, arranged for example facing the combustion chamber 27.

To allow this bleeding, the first and the second channel 310, 320 comprise respectively a solenoid valve 311, 321, and a check valve 312, 322 arranged downstream of the solenoid valve 311, 321. It will be noted that the solenoid valves 311, 321, as well as the three-way valves or the movable and blockable check valves described in the continuation of the description, can be controlled by a control unit (not shown), which can be a “FADEC” (Full Authority Digital Engine Control).

Thus, the solenoid valves 311, 321 can be controlled independently of one another, to be able to bleed a hot air flow rate q₁ and q₂ respectively from the first and/or from the second engine 1, 2. Consequently, the total hot air flow rate qₜ flowing in the downstream channel 330 to the equipment of the propulsion assembly is the sum of the flow rates q₁ and q₂ flowing in the first and the second bleed channel 310 and 320 respectively, i.e. qₜ=q₁+q₂.

Moreover, this twin-engine architecture allows an economical operating mode, called the “ECO” mode in the continuation of the description, in which one of the two engines operates in standby mode, i.e. is stopped (combustion chamber “OFF”) or rotates at super-low idle (for example at a rotation speed less than 40% of the nominal rotation speed), while the other engine supplies the entire power. In the first embodiment described with reference to FIG. 1, the engine operating in standby mode is the second engine 2, the first engine 1 supplying the entire power. This example is not limiting, however; this configuration being able to be reversed without departing from the scope of the invention.

During operation in ECO mode, the solenoid valve 321 of the second engine is closed, so that the air flow rate q₂ supplied by the second engine 2 is nil, i.e. q₂=0, so that qₜ=q₁. In this configuration, during cruise flight, conditions in which ice can appear on the components of the second engine 2 are likely to occur. Moreover, the low temperature within the combustion chamber 27 does not allow easy and rapid starting of the second engine 2 in case of necessity.

It will be noted that these conditions, called icing flight conditions, or the necessity of heating the combustion chamber 27, can be determined by sensors such as thermocouples (not shown) arranged in the second engine 2, and connected to the control unit.

To limit the disadvantages linked to these conditions, the propulsion assembly 100 is equipped with a secondary air flow device 40 comprising, according to the first embodiment, a third bleed channel 410, connecting the first engine 1 to the second engine 2.

In particular, the third bleed channel 410 is configured to bleed hot air from the first engine 1, by means of a second bleed point 413, distinct from the first bleed point 313. The first engine 1 can for example comprise two air bleed bosses, the first bleed point 313 being connected to one of the two bosses, and the second bleed point 413 being connected to the other of the two bosses.

Moreover, the third bleed channel 410 is configured to convey hot air and to inject it into the second engine 2 by means of an injection point 414, distinct from the first bleed point 323 of the second engine 2. The second engine 2 can for example comprise, in the same manner as the first engine 1, two air bleed bosses, the first bleed point 323 being connected to one of the two bosses, and the injection point 414 being connected to the other of the two bosses.

The locations for bleeding by the second bleed point 413, and for injection by the injection point 414, can be determined based on the needs for anti-icing or maintaining the temperature of the components of the second engine 2, and therefore on the temperature and/or air flow rate needs.

In particular, the selection of the position of the second bleed point 413 can be determined considering an optimum between the need for the energy necessary for heating the second engine 2 in standby mode and the impact on the performance of the active first engine 1. Thus the bleeding of air from the first engine can occur at the outlet of the compressor 15, between several stages of the compressor 15, or at the combustion chamber 17. Moreover, the injection of air into the second engine 2 can occur at the air inlet 29, via the air circuits present in the pre-rotation vanes, between the stages of the compressor 25, or around the combustion chamber 27 via its casing, as illustrated in FIG. 1.

In order to allow the transfer of an air flow rate q₁′ from the first engine 1 to the second engine 2, the third bleed channel 410 is equipped with a solenoid valve 411, and with a check valve 412 downstream of the solenoid valve 411, in the flow direction of the air in the third channel 410 from the first engine 1 to the second engine 2, symbolized by the arrow next to the reference symbol q₁′ in FIG. 1. Thus, in ECO mode, while the primary air circulation device 30 supplies an air flow rate qₜ=q₁, the active first engine 1 supplies a total air flow rate q₁+q₁′, distributed between the primary air flow device 30 and the secondary air flow device 40.

It will be noted that the quantity of air bled and injected by the secondary air circulation device 40 into the second engine 2 in standby mode can be dependent on outside conditions and/or icing conditions and/or the thermal condition of the second engine 2; or other parameters can be relevant for optimizing the need for air flow. This flow rate can be managed via an angular position of the solenoid valve 411 controlled by the control unit.

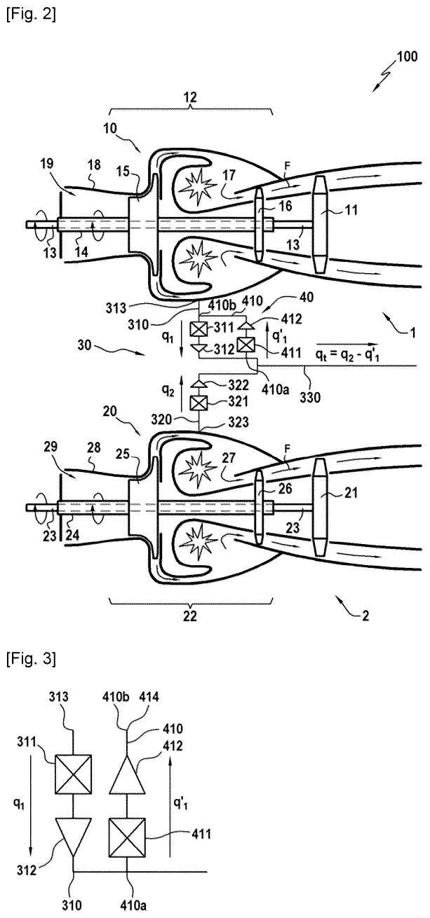

An architecture of a propulsion assembly 100 according to a second embodiment of the invention will be described in the continuation of the description, with reference to FIGS. 2 to 8. The features linked to the first and second engines 1 and 2 are identical to the first embodiment, and will not be repeated again.

According to the second embodiment, the secondary air circulation device 40 is arranged on the primary air circulation device 30, involving a modification of the latter. It will be noted, however, that the primary air circulation device 30 according to the second embodiment also comprises a first and a second bleed channel 310, 320, and a downstream channel 330. The first bleed points 313, 323 can also be identical to the first embodiment.

In the second embodiment, the engine operating in standby mode is the first engine 1, the second engine 2 supplying the entire power. This example is not limiting, however, this configuration being able to be reversed without departing from the scope of the invention. In this regard, it is understood that the second bleed channel 320 is identical to the first embodiment, and comprises in particular a solenoid valve 321 and a check valve 322 downstream of the latter.

The secondary air circulation device 40 comprises a bypass device, which can be arranged on the first bleed channel 30, involving modification of the latter relative to the first embodiment, or comprise a bypass channel attached to the first bleed channel 30 without modification of the latter relative to the first embodiment, depending on the application examples of the second embodiment described hereafter with reference to FIGS. 2 to 8.

In a first example shown in FIG. 2, the bypass device of the secondary air circulation device 40 comprises a bypass channel 410 arranged in parallel with the first bleed channel 310, which is identical to the first bleed channel 310 described with reference to FIG. 1, comprising in particular a solenoid valve 311 and a check valve 312 downstream of the latter.

The bypass channel 410 extends between a first end 410a communicating with the first bleed channel 310 downstream of the check valve 312, and a second end 410b communicating with the first bleed channel 310 between the solenoid valve 311 and the first bleed point 313. The bypass channel 410 also comprises a solenoid valve 411 and a check valve 412 arranged downstream of the solenoid valve 411 according to the flow direction of the air between the first end 410a and the second end 410b.

The check valve 312 of the first bleed channel 310 and the check valve 412 of the bypass channel 410 are mounted in opposition relative to one another. Thus, the check valve 412 of the bypass channel 410 prevents air flows from the first bleed point 313 to the downstream channel 330. In other words, the air bled by the first bleed point 313 can only flow to the downstream channel by means of the first bypass channel 310. Likewise, the check valve 312 of the first bleed channel 310 prevents air flows from the second ending 2 to the first engine 1. In other words, the air originating from the second engine 2 can only flow to the first engine by means of the bypass channel 410.

Thus, when icing flight conditions are detected by the control unit, the latter controls the opening of the solenoid valve 411 of the bypass channel 410, and preferably also the closing of the solenoid valve 311 of the first bleed channel 310. Considering the existing pressure differences between the active second engine 2 and the first engine 1 in standby mode, a part of the air bled from the second engine 2 by the first end 323 is deflected toward the first engine 1 by means of the bypass channel 410, the other part flowing in the downstream channel 330. In addition, the second end 410b of the bypass channel 410 opening into the first bleed channel 310 between the solenoid valve 311 and the first bleed point, the air originating from the second engine 2 is injected into the first engine 1 through the first bleed point 313.

Consequently, in the ECO mode shown in FIG. 2, the total air flow rate flowing in the downstream channel 330 is equal to qₜ=q₂−q₁′. It will be noted that outside of ECO mode, the solenoid valve 411 is closed, and the solenoid valve 311 is open, so that q₁′=0, and qₜ=q₁+q₂.

FIGS. 3 to 8 show modified examples of the second embodiment. In these figures, only the first bleed channel 310 and the bypass channel 410, when such a channel exists, are shown in order to simplify the description of these examples. However, the other elements of the propulsion assembly 100 (particularly the second bleed channel 320 and the downstream channel 330), though not shown, are also present and remain identical to the description of them that is given above, with reference to FIG. 2.

The example shown in FIG. 3 differs from the example described with reference to FIG. 2 in that the second end 410b of the bypass channel 410 does not communicate with the first bleed channel 310, but opens directly into the first engine 1, by means of an injection point 414 distinct from the first bleed point 313. Consequently, according to this example, air originating from the second engine 2 is not injected into the first engine 1 by the same air bleed point in the first engine, namely the first bleed point 313, but by an injection point 414 distinct from the latter.

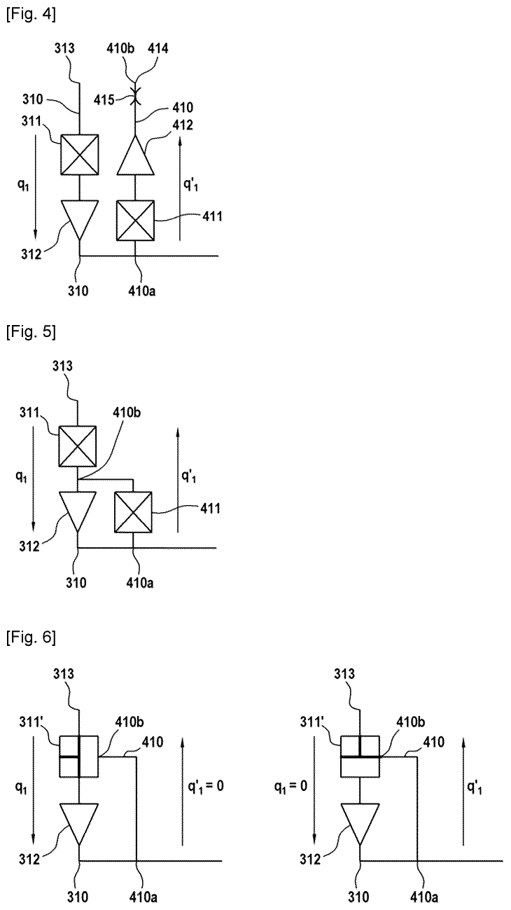

The example shown in FIG. 4 differs from the example described with reference to FIG. 3 in that the bypass channel 410 comprises a limiter 415 arranged downstream of the check valve 412, more precisely between the check valve 412 and the injection point 414. The limiter 415 can be an adjustable constriction of the passage cross section of the bypass channel 415, allowing regulating the air flow injected into the first engine 1, depending on the needed flow rate and temperatures of the zones or of the components to be heated. The limiter 415 can also be controlled by the control unit.

The example shown in FIG. 5 differs from the example described with reference to FIGS. 2 and 3 in that the second end 410b of the bypass channel 410 communicates with the first bleed channel 310, between the solenoid valve 311 and the check valve 312. In addition, the bypass channel 410 comprises only one solenoid valve 411, but no check valve. According to this configuration, the transfer of air from the second engine 2 to the first engine 1 is thus allowed by the opening of the solenoid valve 311 and of the solenoid valve 411, the bypass channel 410 acting as a bridge (or “bypass”) allowing circumventing the check valve 312 of the first bleed channel 310.

According to the example shown in FIG. 6, the solenoid valve 311 of the first bleed channel 310 is replaced by a three-way valve 311′, movable between a first position (left image in FIG. 6) allowing an air flow in the first bleed channel 310 and preventing an air flow in the bypass channel 410, and a second position (right image in FIG. 6) preventing an air flow in the first bleed channel 310 and allowing an air flow in the bypass channel 410. In this example, the bypass channel 410 is a simple duct, with no solenoid valve or check valve. In addition, the three-way valve is also preferably controlled by the control unit.

Thus, outside ECO mode, the three-way valve 311′ is placed in its first position, so as to allow an air flow rate q₁ from the first bleed point 313 (q₁′=0). On the contrary, in ECO mode, the three-way valve 311′ is placed in its second position, so as to allow an air flow rate q₁′ from the second engine 2 to the first bleed point 313 of the first engine 1 (q₁=0).

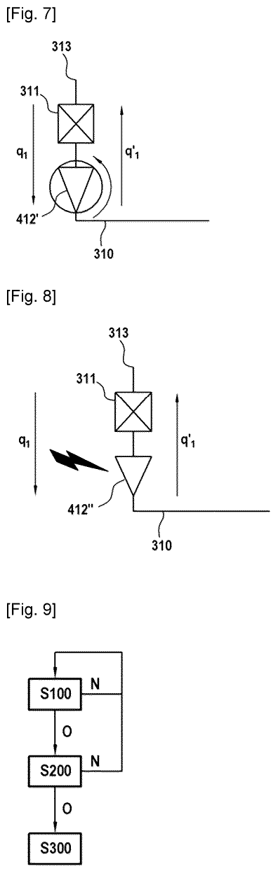

According to the example shown in FIG. 7, the bypass device of the secondary air flow device 40 does not comprise a bypass channel, but comprises a movable check valve 412′, arranged in place of the check valve 312 of the first bleed channel 310. The movable check valve 412′ is movable, by pivoting on itself, between a first position allowing an air flow in the first bleed channel 310 from the first bleed point 313 of the first engine 1 to the downstream channel 330, and a second position allowing an air flow from the second engine 2 to the first engine 1. The rotation movement of the movable check valve 412′ is shown by the curved arrow in FIG. 7.

It is also understood that in the first position, the movable check valve 412′ prevents an air flow to the first bleed point 313, and in the second position the movable check valve 412′ prevents an air flow from the first bleed point 313 to the downstream channel 330. Thus, outside ECO mode, the movable check valve 412′ is held in the first position by the control unit, and in ECO mode the movable check valve 412′ is placed in the second position by the control unit, to allow a transfer of air from the second engine 2 to the first engine 2, this transfer being allowed moreover by the existing pressure differences between these engines.

The example shown in FIG. 8 differs from the example described with reference to FIG. 7 in that the movable check valve 412′ is replaced by a blockable check valve 412″, configured to be blocked and held in the open position by the control unit. Thus, in ECO mode, the blockable check valve 412″ is held in the open position by the control unit, to allow a transfer of air from the second engine 2 to the first engine 2, this transfer being allowed, moreover, by the existing pressure differences between these engines. On the contrary, outside ECO mode, the blockable check valve 412″ resumes its normal operation, and prevents the return of air to the first engine 1.

FIG. 9 shows schematically the different steps of a thermal management method for the propulsion assembly 100.

In a first step (step S100), the control unit detects whether one of the engines is operating in standby mode. If it is detected that no engine is operating in standby mode, corresponding to operation outside ECO mode of the propulsion assembly (“N” at step S100), the method returns to step S100.

If it is detected that one of the engines is operating in standby mode (“N” in step S100), the control unit determines whether the propulsion unit 100 is in icing flight conditions, or if a criterion for needing to heat the combustion chamber, for example, is satisfied (step S200). To this end, the control unit detects whether one at least of the sensors previously mentioned is measuring a temperature less than or equal to a predetermined threshold value. If it is detected that none of these conditions is satisfied, i.e. in the absence of icing flight conditions (“N” in step S200), the method returns to step S100.

If it is detected that at least one of these conditions is satisfied, implying the existence of icing flying conditions (“O” in step S200), the control unit then allows the transfer of air from the active engine to the engine operating in standby mode (step S300). To this end, the control unit commands the opening or the activation of the valves or check valve mentioned previously with reference to the first embodiment or to different examples of application of the second embodiment, particularly the solenoid valve 411, the three-way valve 311′, the movable check valve 412′, or the blockable check valve 412″.

It will be noted that the criterion for needing to heat (step S200) can be based on the internal temperature of the engine in standby mode, which is just like the temperature of the components, and/or the temperature of the oil used for cooling the engine, and/or on a criterion of time passed at a given temperature, or possibly on the presence or not of rain, associated with an altitude.

In addition, the bleeding and the transfer of air from one engine to another (step S300) can be maintained as long as the conditions detected at step S200 are true, taking into consideration a hysteresis to avoid untimely openings and closings.

Although the present invention has been described by referring to specific exemplary embodiments, it is obvious that modifications and changes can be applied to these examples without departing from the general scope of the invention as defined by the claims. In particular, individual features of the different embodiments illustrated/mentioned can be combined into additional embodiments. Consequently, the description and the drawings should be considered in an illustrative, rather than a restrictive sense.

It is also obvious that all the features described with reference to a method are transposable, alone or in combination, to a device, and conversely, all the features described with reference to a device are transposable, alone or in combination, to a method.

1. A propulsion assembly (100) for an aircraft, particularly for a multi-engine helicopter, comprising:
at least one first engine (1) and a second engine (2) configured to operate in at least one standby mode,
a primary air circulation device (30) configured to bleed air from the first engine (1) via a first bleed channel (310) and/or from the second engine (2) via a second bleed channel (320) for conveying it to equipment of the propulsion assembly (100), and
a secondary air circulation device (40) configured, when one of the first or the second engine (1, 2) operates in the at least one standby mode, to bleed air originating from the other of the first or the second engine (1, 2) not operating in standby mode and to convey it to the first or the second engine (1, 2) operating in standby mode,
wherein the secondary air circulation device (40) comprises a bypass device arranged on one of the first or the second bleed channel (310, 320), the first and the second bleed channel (310, 320) comprise a solenoid valve (311, 321) and a check valve (312, 322), the bypass device comprising a bypass channel (410) comprising a solenoid valve (411), a first end (410a) of the bypass channel (410) being in communication with said first or second bleed channel (310, 320) downstream of the check valve (312, 322) of said first or second bleed channel (310, 320), a second end (410b) of the bypass channel (410) being in communication with said first or second bleed channel (310, 320) upstream of the check valve (312, 322).

2. The propulsion assembly (100) according to claim 1, wherein the bypass device is configured to allow an air flow originating from one of the first or second engine (1, 2) not operating in standby mode to the other of the first or second engine (1, 2) operating in standby mode, while preventing an air flow in the opposite direction.

3. The propulsion assembly (100) according to claim 1 or 2, the second end (410b) of the bypass channel (410) being in communication with said first or second bleed channel (310, 320) between the solenoid valve (311, 321) and the check valve (312, 322) of said first or second bleed channel (310, 320).

4. The propulsion assembly (100) according to claim 1 or 2, wherein the first and the second bleed channel (310, 320) are configured to bleed air from the first and from the second engine (1, 2) at a bleed point (313, 323) of the first and the second engine (1, 2) respectively, the bypass channel (410) comprising a check valve (412) mounted in opposition to the check valve (312, 322) of the first or the second bleed channel (310, 320), the second end (410b) of the bypass channel (410) being in communication with said first or second bleed channel (310, 320), between the solenoid valve (311, 321) and the bleed point (313, 323) of said first or second bleed channel (310, 320).

5. A propulsion assembly (100) for an aircraft, particularly a multi-engine helicopter, comprising:
at least one first engine (1) and a second engine (2) configured to operate in at least one standby mode,
a primary air circulation device (30) configured to bleed air from the first engine (1) via a first bleed channel (310) and/or from the second engine (2) via a second bleed channel (320) to convey it to equipment of the propulsion assembly (100), and
a secondary air circulation device (40) configured, when one of the first or second engines (1, 2) operates in the at least one standby mode, to bleed air originating from the other of the first or second engine (1, 2) not operating in standby mode and to convey it to the first or second engine (1, 2) operating in standby mode,
wherein the secondary air circulation device (40) comprises a bypass device arranged on one of the first or the second bleed channel (310, 320), the first and the second bleed channel (310, 320) comprise a solenoid valve (311, 321) and a check valve (312, 322), the bypass device comprising a bypass channel (410) comprising a solenoid valve (411), a first end (410a) of the bypass channel (410) being in communication with said first or second bleed channel (310, 320) downstream of the check valve (312, 322) of said first or second bleed channel (310, 320), wherein the first and the second bleed channel (310, 320) are configured to bleed air from the first and the second engine (1, 2) at a bleed point (313, 323) of the first and the second engine (1, 2) respectively, the bypass channel (410) comprising a check valve (412) mounted in opposition to the check valve (312, 322) of the first and second bleed channel (310, 320), a second end (410b) of the bypass channel (410) being configured to inject air into the first or second engine (1, 2) operating in standby mode, at an injection point (414) distinct from the bleed point (313, 323), the bypass channel (410) comprising a limiter (415) arranged between the check valve (412) and the injection point (414), the limiter (415) being configured to regulate a flow rate of air flowing in the bypass channel (410).

6. A propulsion assembly (100) for an aircraft, particularly for a multi-engine helicopter, comprising:
at least one first engine (1) and a second engine (2) configured to operate in at least one standby mode,
a primary air circulation device (30) configured to bleed air from the first engine (1) via a first bleed channel (310) and/or from the second engine (2) via a second bleed channel (320) to convey it to equipment of the propulsion assembly (100), and
a secondary air circulation device (40) configured, when one of the first or the second engine (1, 2) operates in the at least one standby mode, to bleed air originating from the other of the first or the second engine (1, 2) not operating in standby mode and convey it to the first or the second engine (1, 2) operating in standby mode,
wherein the secondary air circulation device (40) comprises a bypass device arranged on one of the first or the second bleed channel (310, 320), the first and the second bleed channel (310, 320) comprising a three-way valve (311′) and a check valve (312), the bypass device comprising a bypass channel (410), a first end (410a) of the bypass channel (410) being in communication with said first or second bleed channel (310, 320) downstream of the check valve (312) of said first or second bleed channel (310, 320), a second end (410b) of the bypass channel (410) being connected to the three-way valve (311′), the three-way valve (311′) being movable between a first position allowing an air flow in said first or second bleed channel (310, 320) and preventing an air flow in the bypass channel (410), and a second position preventing an air flow in said first or second bleed channel (310, 320) and allowing an air flow in the bypass channel (410).

7. A propulsion assembly (100) for an aircraft, particularly for a multi-engine helicopter, comprising:
at least one first engine (1) and a second engine (2) configured to operate in at least one standby mode,
a primary air circulation device (30) configured to bleed air from the first engine (1) via a first bleed channel (310) and/or from the second engine (2) via a second bleed channel (320) to convey it to equipment of the propulsion assembly (100), and
a secondary air circulation device (40) configured, when one of the first or the second engine (1, 2) operates in the at least one standby mode, to bleed air originating from the other of the first or the second engine (1, 2) not operating in standby mode and to convey it to the first or the second engine (1, 2) operating in standby mode,
wherein the secondary air circulation device (40) comprises a bypass device arranged on one of the first or the second bleed channel (310, 320), the first and the second bleed channel (310, 320) comprising a solenoid valve (311, 321), the bypass device comprising a movable check valve (412′) arranged on the first or on the second bleed channel (310, 320), the movable check valve (412′) being movable between a first position allowing an air flow in said first or second bleed channel (310, 320) in a first circulation direction and preventing an air flow in a second circulation direction, opposite to the first direction, and a second position allowing an air flow in the second circulation direction and preventing an air flow in the first circulation direction.

8. A propulsion assembly (100) for an aircraft, particularly a multi-engine helicopter, comprising:
at least one first engine (1) and a second engine (2) configured to operate in at least one standby mode,
a primary air circulation device (30) configured to bleed air from the first engine (1) via a first bleed channel (310) and/or from the second engine (2) via a second bleed channel (320) to convey it to equipment of the propulsion assembly (100), and
a secondary air circulation device (40) configured, when one of the first or the second engine (1, 2, operates in the at least one standby mode, to bleed air originating from the other of the first or second engine (1, 2) not operating in standby mode and to convey it to the first or the second engine (1, 2) operating in standby mode,
wherein the secondary air circulation device (40) comprises a bypass device arranged on one of the first or the second bleed channel (310, 320), the first and the second bleed channel (310, 320) comprising a solenoid valve (311, 321), the bypass device comprising a blockable check valve (412″) arranged on the first or the second bleed channel (310, 320), the blockable check valve (412″) being configured to be blocked in an open position allowing an air flow in two circulation directions.

9. A thermal management method for a propulsion assembly (100) according to any one of the previous claims, comprising:
detecting operation in at least one standby mode by one of the first engine (1) or the second engine (2),
measuring the temperature of at least one component of said first engine (1) or second engine (2) operating in the standby mode, and
if the measured temperature is less than or equal to a predetermined threshold value, bleeding air from the other of the first engine (1) or the second engine (2) not operating in standby mode, and conveying air to the first engine (1) or the second engine (2) operating in standby mode, by means of the secondary air circulation device (40).
